(19) United States
(12) Patent Application Publication
(10) Pub. No.: US 2024/0320538 A1
(43) Pub. Date: Sep. 26, 2024

(54) ANOMALOUS DATA IDENTIFICATION FOR TABULAR DATA

(71) Applicant: ADOBE INC., SAN JOSE, CA (US)

(72) Inventors: Ramasuri NARAYANAM, Bangalore (IN); Shiv Kumar SAINI, Bangalore (IN); Koyel MUKHERJEE, Bangalore (IN); Manisha PADALA, Hyderabad (IN); Keshav VADREVU, San Jose, CA (US); Gautam CHOUDHARY, West Lafayette, IN (US); Atharv TYAGI, Bengaluru (IN)

(21) Appl. No.: 18/123,673

(22) Filed: Mar. 20, 2023

(51) Int. Cl. G06N 20/00

(52) U.S. Cl. CPC G06N 20/00

(57) ABSTRACT

Systems and methods identify anomalous data in tabular data. A set of tabular data records is received. Each tabular data record includes data elements for a numbers of attributes, with each data element providing a value for a corresponding attribute. An anomaly score is generated for each data element of each tabular data record. Additionally, an evidence set is defined for each attribute and each tabular data record based on the anomaly scores for the data elements. An anomaly score is generated for each attribute and each tabular data record using the evidence sets. An output is provided that identifies one or more anomalous data subsets determined based on the anomaly scores for the attributes and tabular data records. Each anomalous data subset identifies a subset of attributes and a subset of tabular data records.

### BACKGROUND

Artificial intelligence (AI)-based systems are being deployed for a wide variety of applications. At a high level, AI systems typically comprise two major components: models and data used to train the models. In some cases, tabular data is used to train models. Tabular data is data that can be represented as a table with rows representing records, and columns representing attributes. Each record comprises a collection of data elements that provide a value for a corresponding attribute. The quality of tabular data can significantly impact the ability to successfully train models on the data. For instance, noise in tabular data impedes performance of machine learning models trained on the data. To alleviate this multiple techniques have been proposed to identify noise, filter the noise, and train models using a cleaned subset of data. Although existing approaches can be somewhat helpful in cleaning data, they are not effective in garnering the sources of anomalies in them.

### SUMMARY

Some aspects of the present technology relate to among other things, a system that identifies, analyzes, and provides insights to anomalies in tabular data. In some aspects, the insights comprise anomalous data subsets identified in the tabular data. Each anomalous data subset identifies a subset of attributes having anomalous data and a subset of records indicative of that anomalous data. In some configurations, the anomalous data subsets are ranked based on extent of anomalous data in the corresponding subset of attributes and record in each anomalous data subset.

The system receives tabular data comprising a set of records. Each record includes data elements setting forth values for corresponding attributes. The tabular data is processed to identify anomalous data elements. For instance, an anomaly score can be determined for each data element that is indicative of a likelihood each data element is anomalous. In some aspects, the anomaly scores for data elements are based on reconstruction errors determined using a machine learning model (e.g., an autoencoder). In some configurations, each data element is labeled based on its likelihood of being anomalous. Evidence sets are defined for attributes and records based on the identification of anomalous data elements. In some aspects, an evidence set for an attribute is the set of records in which the data element for that attribute is identified as likely being anomalous, while an evidence set for a record is the set of attributes in which the data element for the attribute is identified as likely being anomalous. Anomaly scores for attributes and records are determined using the evidence sets. In some instances, the anomaly scores are Shapley values. An output is provided that identifies one or more anomalous data subsets determined based on the anomaly scores for the attributes and tabular data records.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram illustrating an example of generating anomalous data subsets from input tabular data in accordance with some implementations of the present disclosure;

FIG. 3 is a diagram illustrating an example of labeling data elements in tabular data in accordance with some implementations of the present disclosure;

FIG. 4 is a diagram illustrating an example of evidence sets generated from labeled tabular data and Shapley values computed from the evidence sets in accordance with some implementations of the present disclosure;

FIG. 5 is a diagram illustrating an example of restructuring tabular data based on anomaly scores for attributes and records and identification of anomalous data subsets in the tabular data in accordance with some implementations of the present disclosure;

FIG. 6 is a flow diagram showing a method for generating anomalous data subsets from tabular data in accordance with some implementations of the present disclosure; and

FIG. 7 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, “tabular data” refers to information that can be represented as a table in rows and columns. In some aspects, each row corresponds to a record, and each column corresponds to an attribute.

A “record” (or “tabular data record”) is a collection of information for a single observation, entity, or item. A record comprises a data set that includes information for attributes for the tabular data. As noted above, in some aspects, a record corresponds to a row in the tabular data.

An “attribute” refers to a characteristic, feature, or property. As noted above, in some aspects, an attribute corresponds to a column in the tabular data.

A “data element” comprises a value of a given attribute for a given record in tabular data. In some instances, a data element corresponds to the intersection of a record (e.g., row) and an attribute (e.g., column) in the tabular data.

As used herein, an “anomaly score” refers to a value that represents a likelihood or extent of anomaly in tabular data. In some aspects of the technology described herein, an anomaly score for a data element is a value indicative of a likelihood that the data element is anomalous. The anomaly score for a data element, for instance, can be based on a prediction or reconstruction error determined using a machine learning model (e.g., an autoencoder) trained to predict values of attributes for records given values for other attributes. In some aspects of the technology described herein, an anomaly score for an attribute or a record is a value indicative of an extent to which an attribute or a record contains anomalous data. The anomaly score for an attribute or a record, for instance, can be based on a Shapley value computed using an evidence set for an attribute or a record.

An “evidence set” for an attribute is a set of records in which the data element for that attribute is identified as likely being anomalous. An “evidence set” for a record is a set of attributes in which the data element for the attribute is identified as likely being anomalous.

### Overview

Currently, there are a number of techniques for anomaly detection in tabular datasets. These anomaly detection techniques often focus on one or more specific types of errors, such as numeric outliers, constraint violation, functional dependency violation, and spelling mistakes, to name a few. Some approaches for flagging anomalies in tabular data rely on reconstruction-based loss from auto-encoders. Other approaches use generative adversarial models that are semi-supervised and more suited for images. Some approaches, such as distance-based and clustering-based anomaly detection, are also used for detecting anomalous samples in data. Yet another approach is self-supervised classification for tabular data where the normality is determined by how well each attribute of a given row is predicted given the values of other attributes in the same row. Other approaches using memory networks are more suited for learning complex patterns in data and provide better precision in detecting anomalies. Further approaches detect anomalies using isolation forest. However, each of these existing anomaly detection techniques primarily focus on identifying anomalous data elements and do not fully consider the extent of anomalies in attributes and records.

Some current work has also focused on the explainability of detected anomalies. For instance, there is various work that learns feature importance scores or explanations for why a sample is predicted to be anomalous, for instance, in images and videos. There is also some existing work for deriving feature importance for tabular data. For instance, the use of Attention-guided Triplet deviation network for Outlier interpretatioN (ATON) has been proposed to provide feature weights, although it requires access to data which is known to be non-anomalous. Another work provides input feature relevance scores for predicting a sample anomalous. This work uses a layer-wise relevance propagation approach that requires label information with the assumption that supervision is available. In other work, few shot learning is considered; i.e., limited supervision and learning end to end scoring rule. Yet another approach that provides explanations for anomalies in time series data is EXAD (a system for explainable anomaly detection), where there is an assumption that supervision is present. In further work, few attributes that have high reconstruction errors are identified, and Shapley additive explanations are provided for each of these attributes without an indication of records that localize the errors. In other work, attribute importance is specifically designed to work on isolation forest-based anomaly detection. Still further work use attribute importance scores for detecting different kinds of network intrusion. These scores are derived from gradient-based method for the reconstruction loss in a VAE. While these approaches provide some insight to anomalies in data, they fall short in providing information to address the source of anomalies in the data.

Aspects of the technology described herein improve the functioning of the computer itself in light of these shortcomings in existing technologies by providing a system that identifies, analyzes, and provides insights to anomalies in tabular data. In some configurations, the technology described herein identifies anomalous data subsets in tabular data as data quality insights. Each anomalous data subset identifies a subset of attributes having anomalous data and a subset of records indicative of that anomalous data. In some aspects, the anomalous data subsets are ranked based on extent of anomalous data in the corresponding subset of attributes and record in each anomalous data subset.

In accordance with some aspects of the technology described herein, tabular data is received as input. The tabular data includes a set of records having data elements, in which each data element provides a value for a corresponding attributes. The tabular data is analyzed to identify anomalous data elements in the tabular data. In some instances, the system determines an anomaly score for each data element that is indicative of a likelihood of each data element being anomalous. The anomaly scores for data elements can be generated using any of a number of different techniques. By way of example only and not limitation, in some configurations, the anomaly scores are based on prediction error determined using a machine learning model trained to predict values for attributes in the tabular data based on actual values for other attributes in the tabular

Evidence sets are defined for attributes and records based on the identification of anomalous data elements. In some aspects, an evidence set for an attribute is the set of records in which the data element for that attribute is identified as likely being anomalous (e.g., based on the anomaly scores and/or labels). In some aspects, an evidence set for a record is the set of attributes in which the data element for the attribute is identified as likely being anomalous (e.g., based on the anomaly scores and/or labels).

The system determines anomaly scores for attributes and records using the evidence sets. In some configurations, the anomaly scores are Shapley values. For instance, in some configurations, a cooperative game is defined using the evidence sets for the attributes and the records as players, and Shapley values are computed for the attributes and the records based on the cooperative game. Anomalous data subsets are determined using the anomaly scores for the attributes and the records. Each anomalous data subset identifies a subset of attributes and subset of records that contain anomalous data. In some configurations, the anomalous data subsets are ranked based the relative extent of their anomalies (e.g., based on the anomaly scores for the attributes and records in each anomalous data subset).

An output identifying the anomalous data subsets is provided. In some configurations, the output comprises an indication of attributes and records for each anomalous data subset, and the anomalous data subsets can be ordered based on the extent of their anomalous data. In some instances, the output comprises restructured tabular data in which attributes and records are ordered based on their anomaly scores. For instance, restructured tabular data could be provided in which the most anomalous attributes (e.g., attributes with the highest anomaly scores) are shifted to the left and the most anomalous records (e.g., records with the highest anomaly scores) are shifted towards the top. The restructured tabular data could also provide a visual indicator (e.g., highlighting, cross-hatching, boxing, etc.) identifying anomalous data subsets.

Aspects of the technology described herein provide a number of improvements over existing technologies. For instance, tabular datasets often suffer from data inconsistencies/anomalies spanning multiple attributes. That is there can potentially be several combinations of attributes associated with data inconsistencies. Thus, aspects of the present technology identify and present these combinations of anomalous attributes commensurate with the extent of anomalous behavior. In some aspects, the system provides for rank ordering these collections of attributes as per the extent of their anomalous behavior. Further, the system described herein accompanies each collection of anomalous attributes with a subset of records wherein the anomalous behavior of attributes in the collection is observed. Some aspects of the technology described herein address the following challenges with identifying and generating such data quality insights: (i) different variants of anomalies can be present in the data and also lack of supervision (as it is costly to obtain labels for anomalous entries in the data); (ii) exponentially many candidate groups of attributes is a serious impediment to the design of efficient algorithms; and (iii) complex dependencies among attributes can make it hard to identify the actual sources of anomalies. By addressing these challenges, the technology described herein provides anomalous data subsets as data quality insights that serve as pointers to the sources of anomalies in the data and also aid in rectifying them during the data collection process. As a result, the tabular data can be better cleansed of anomalous data. Additionally, the sources of data anomalies can be addressed, thereby reducing the extent of anomalous data collected. Consequentially, the technology described herein reduces the extent of anomalies in tabular data, improving the ability to successfully train models on the tabular data. This reduces the consumption of computing resources traditionally required in retraining models when the quality of the training data is reduced.

### Example System for Anomalous Data Identification

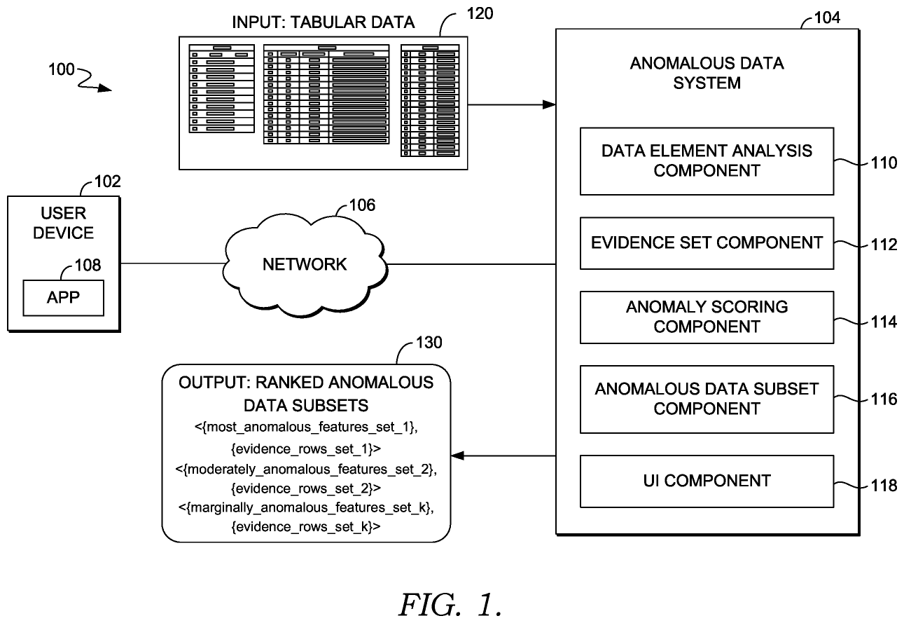

With reference now to the drawings, FIG. 1 is a block diagram illustrating an exemplary system 100 for identifying anomalous data in tabular data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

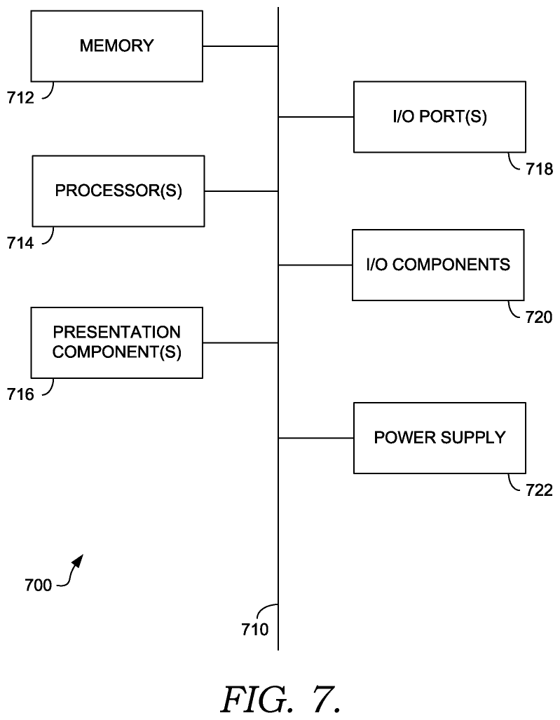

The system 100 is an example of a suitable architecture for implementing certain aspects of the present disclosure. Among other components not shown, the system 100 includes a user device 102 and an anomalous data system 104. Each of the user device 102 and anomalous data system 104 shown in FIG. 1 can comprise one or more computer devices, such as the computing device 700 of FIG. 7, discussed below. As shown in FIG. 1, the user device 102 and the anomalous data system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and server devices can be employed within the system 100 within the scope of the present technology. Each can comprise a single device or multiple devices cooperating in a distributed environment. For instance, the anomalous data system 104 could be provided by multiple server devices collectively providing the functionality of the anomalous data system 104 as described herein. Additionally, other components not shown can also be included within the network environment.

The user device 102 can be a client device on the client-side of operating environment 100, while the anomalous data system 104 can be on the server-side of operating environment 100. The anomalous data system 104 can comprise server-side software designed to work in conjunction with client-side software on the user device 102 so as to implement any combination of the features and functionalities discussed in the present disclosure. For instance, the user device 102 can include an application 108 for interacting with the anomalous data system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the anomalous data system 104 remain as separate entities. While the operating environment 100 illustrates a configuration in a networked environment with a separate user device 104 and anomalous data system 104, it should be understood that other configurations can be employed in which components are combined. For instance, in some configurations, the user device 102 can also provide some or all of the capabilities of the anomalous data system 104 described herein.

The user device 102 comprises any type of computing device capable of use by a user. For example, in one aspect, the user device comprises the type of computing device 700 described in relation to FIG. 7 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user can be associated with the user device 102 and can interact with the anomalous data system 104 via the user device 102.

At a high level, the anomalous data system 104 takes in tabular data, such as the tabular data 120, and outputs ranked anomalous data subsets, such as the ranked anomalous data subsets 130. Each anomalous data subset identifies a grouping of anomalous attributes and records that include anomalous data for those attributes. As described in further detail below, the anomalous data system 104 generates an anomaly score for each attribute and record, and generates the ranked anomalous data subsets based on the anomaly scores. The anomaly scores reflect an extent to which each attribute and record includes anomalous data. In some aspects, the anomaly scores comprise Shapley values computed for the attributes and records.

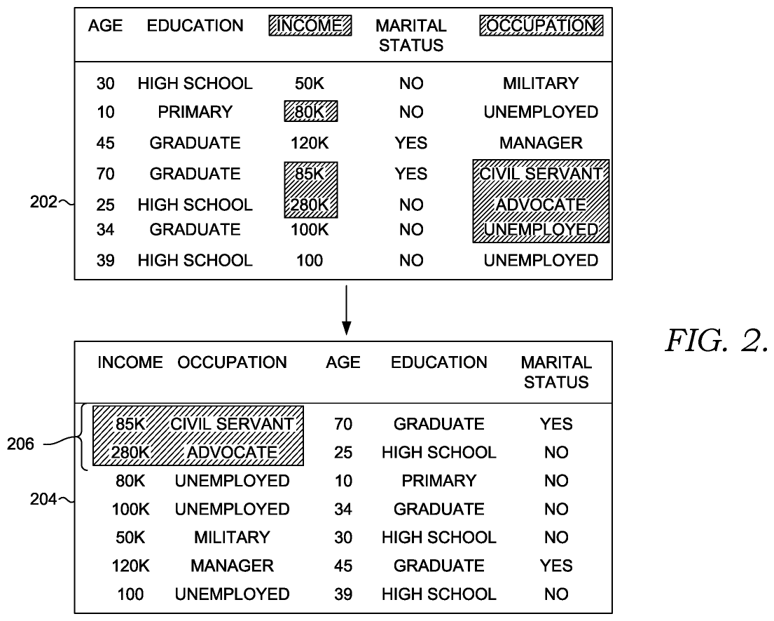

By way of example, FIG. 2 shows tabular data 202, which includes five attributes (i.e., the five columns labeled: “Age”, “Education”, “Income”, “Marital Status”, and “Occupation”) and seven records (i.e., the seven rows). Each record includes a set of data elements that each comprises a value for a corresponding attribute. For instance, the first record (i.e., the first row) in the tabular data 202 includes the following data elements: 30 for the “Age” attribute; high school for the “Education” attribute, 50k for the “Income” attribute; no for the “Marital Status” attribute; and military for the “Occupation” attribute. Given the tabular data 202, some aspects generate an output table 304 in which columns (i.e., attributes) and rows (i.e., records) are reordered based on the extent to which each includes anomalous data. In the example of FIG. 2, the output table 304 has rearranged the columns such that the most anomalous attributes are towards the left-hand side of the table 304, and the most anomalous records are towards the top of the table 304. Additionally, the output table 304 identifies an anomalous data subset 206 that comprises the “Income” and “Occupation” attributes and the fourth and fifth records in the input tabular data 202. While the example of FIG. 2 provides a single anomalous data subset, it should be understood that any number of anomalous data subsets can be provided.

With reference again to FIG. 1, the anomalous data system 104 includes a data element analysis component 110, an evidence set component 112, an anomaly scoring component 114, an anomalous data subset component 116, and a user interface component 118. The components of the anomalous data system 104 can be in addition to other components that provide further additional functions beyond the features described herein. The anomalous data system 104 can be implemented using one or more server devices, one or more platforms with corresponding application programming interfaces, cloud infrastructure, and the like. While the anomalous data system 104 is shown separate from the user device 102 in the configuration of FIG. 1, it should be understood that in other configurations, some or all of the functions of the anomalous data system 104 can be provided on the user device 102.

In one aspect, the functions performed by components of the anomalous data system 104 are associated with one or more applications, services, or routines. In particular, such applications, services, or routines can operate on one or more user devices, servers, can be distributed across one or more user devices and servers, or be implemented in the cloud. Moreover, in some aspects, these components of the anomalous data system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

Given tabular data, such as the tabular data 120, the data element analysis component 110 of the anomalous data system 104 analyzes the tabular data to identify anomalous data elements. In some aspects, the data element analysis component 110 generates an anomaly score for each data element and labels each data element based on its anomaly score. The anomaly score for a data element is indicative of a likelihood the data element is anomalous. In some configurations, the anomaly scores comprise prediction or reconstruction errors determined using a machine learning model (e.g., an autoencoder) trained to predict values of attributes for records given values for other attributes. For instance, any of a number of different unsupervised learning models (such as autoencoders) can be trained to predict values for attributes given values for other attributes in the tabular data and compute reconstruction errors based on the predicted values and the actual values in the tabular data. However, it should be noted that although prediction/reconstruction error is discussed as one approach to provide anomaly scores for data elements, other approaches can be employed within the various embodiments of the present technology.

Labels assigned to the data elements represent the likelihood that each data element is anomalous. In some instances, a binary labeling approach is used in which each data element is labeled with either a first label indicating the data element is likely anomalous (e.g., labeled “anomalous” or “potential anomaly”) or a second label indicating the data element is not likely anomalous (e.g., labeled “not anomalous” or “not a potential anomaly”). In some configurations, labels are assigned based on comparison of anomaly scores for data elements to a threshold. For instance, one label is assigned to a data element if the anomaly score satisfies the threshold, while the other label is assigned to the data element if the anomaly score does not satisfy the threshold.

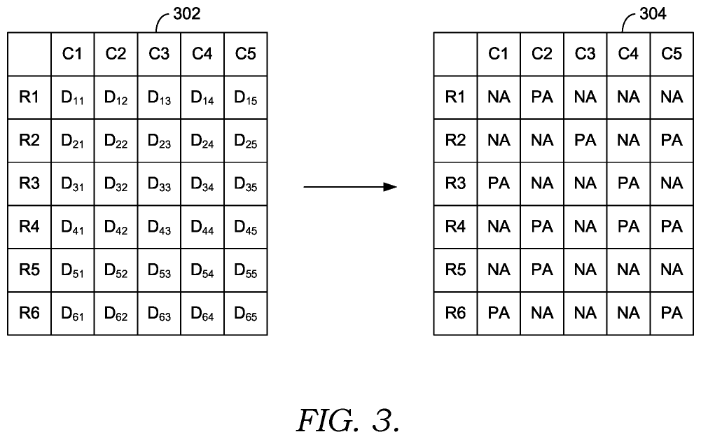

FIG. 3 provides an example of labeling data elements. As shown in FIG. 3, input tabular data 302 is provided that includes five attributes (i.e., the columns: C1, C2, C3, C4, C5) and six records (i.e., the rows: R1, R2, R3, R4, R5, R6). Each record includes a data element for each attribute. For instance, the record R1 includes a first data element D11 for attribute C1, a second data element D12 for attribute C2, a third data element D13 for attribute C3, a fourth data element D14 for attribute C4, and a fifth data element D15 for attribute C5. The labeled tabular data 304 illustrates labels assigned to the data elements, in which data elements labeled “NA” are ones determined not to be potential anomalies and data elements labeled “PA” are ones determined to be potential anomalies.

The following are a few notations used throughout this description. Let T be tabular data with a set of n records and a set A={a₁, a₂, . . . , aₘ} of m attributes (or features). In particular, let T={rᵢ₌₁ⁿ} be a set of n records wherein each record rᵢ=(r₁₁, r₁₂, . . . , rᵢₘ) has m entries corresponding to m attributes. Further, Xᵢⱼ represents the value of attribute aⱼ for record rᵢ. Note i is used to index records and j is used to index attributes. Assume that eᵢⱼ is the absolute error while predicting the value of Xᵢⱼ using an unsupervised learning approach (e.g., an autoencoder). Also, let Lᵢⱼ be the label attached to each Xᵢⱼ based on the prediction error, e₁₁. In particular, Lᵢⱼ can take a label from the set {NA, PA} wherein NA represents Not a potential Anomaly and PA represents Potential Anomaly.

In accordance with some configurations, the data element analysis component 110 initially trains an unsupervised learning model (e.g., an autoencoder) to learn the correlations between the different attributes. The trained model is used to predict a value for each attribute given the values for the other attributes. Using the predicted value and the actual value of the attribute, the reconstruction loss for each data element is computed. The reconstruction loss for each record is computed by taking the average of the loss for each of its attributes. With thresholding on the record level reconstruction losses, which records are anomalous and which are not are determined. For every record predicted as anomalous, the loss values of its attributes are clustered. The attributes belonging to the cluster with higher loss are labelled as anomalous. This process is repeated for every row that is predicted to be anomalous.

Training of Auto-Encoder: In one example implementation, TABNET-based encoder-decoder training is employed. The encoding happens in multiple steps. In each step, only a part of the input is attended to Each step of the encoder has: (i) a Feature Transformer; and (ii) an Attentive Transformer. The encoded representation is fed to the decoder. The decoding happens in multiple steps where a feature transformer is used. Further, the process randomly masks 50% of the features during training, and TABNET predicts only the masked features.

Cell-level Reconstruction Loss: For every test sample i, the process iteratively masks each attribute j and uses the trained TABNET to predict it. The error eᵢⱼ is either the mean-squared error (continuous attributes) or cross-entropy loss (categorical attributes) between the predicted value and the true value of the attribute. To make the loss values comparable across different attributes, the process can standardize the continuous features while the categorical features are normalized to be in between 0 and 1.

Thresholding of Rows: Given the cell-level loss values eᵢⱼ, the record level loss is given by,

$${e}_{i} = \frac{1}{m} {\sum }_{j} {e}_{ij} .$$

In order to identify the threshold on these errors to determine anomalous records, a validation set with limited labelled samples is used. Given the labels on the validation set, the process determines the threshold t* that maximizes the geometric mean between the precision and recall. Based on the threshold, the process derives the row level labels, ŷᵢ∈{0,1} such that ŷᵢ=1 if eᵢ>t* else, ŷᵢ=0. Using the record-level prediction, thresholding of columns is performed as described below.

Thresholding of Columns: Each row i is considered such that it is predicted to be anomalous (i.e., ŷᵢ=1). For each i, the process clusters [eᵢⱼ]_{j={1, . . . ,m}} into two clusters using k-means algorithm. The attributes j belonging to the cluster having higher eᵢⱼ are labelled anomalous, Lᵢⱼ=PA; otherwise Lᵢⱼ=NA. In summary, the cell level predictions Lᵢⱼ are determined, where a label takes value PA if, for an i that is predicted to be anomalous, it is determined that the attribute j is anomalous as described above.

Given an indication of anomalous data elements from the data element analysis component 110 (e.g., anomaly scores and/or labels for the data element), the evidence set component 112 generates evidence sets for attributes and records in the tabular data. In some aspects, an evidence set for an attribute is the set of records in which the data element for that attribute is identified as likely being anomalous (e.g., based on the anomaly scores and/or labels). In some aspects, an evidence set for a record is the set of attributes in which the data element for the attribute is identified as likely being anomalous (e.g., based on the anomaly scores and/or labels).

In some aspects, based on the data element-level label information, evidence sets for each attribute and each record are defined as follows.

Definition 1. Evidence Sets for Attributes: Evidence set Eₐ_{ⱼ} is defined for attribute aⱼ to be the set of records for which the label of aⱼ is PA. That is,

$${E}_{{a}_{j}} = \{ {r}_{i} \vert {X}_{ij} = PA for any i ∈ \{ 1 , 2 , ... , n \} \} \qquad ( 1 )$$

Definition 2. Evidence Sets for Records: We define evidence set Eᵣ_{ᵢ} for record rᵢ to be the set of attributes for which the label is PA. That is,

$${E}_{{r}_{i}} = \{ {a}_{j} \vert {X}_{ij} = PA for any j ∈ \{ 1 , 2 , ... , m \} \} \qquad ( 2 )$$

As an example to illustrate evidence sets with reference to FIG. 3 again, the evidence sets for the attributes in the labeled tabular data 304 are as follows: attribute C1 evidence set={R3, R6}; C2 evidence set={R1, R4, R5}; C3 evidence set={R2}, C4 evidence set={R3, R4}; and C5 evidence set={R2, R4, R6}. The evidence sets for the records in the labeled tabular data 304 are as follows: record R1 evidence set={C2}; record R2 evidence set={C3, C5}; record R3 evidence set={C1, C4}; record R4 evidence set={C2, C4, C5}; record R5 evidence set={C2}, and record R6 evidence set={C1, C5}.

The anomaly scoring component 114 generates an anomaly score for each attribute and each record using the evidence sets. In some aspects, the anomaly score comprises a Shapley value. For instance, a cooperative game is defined in some configurations using the evidence sets for attributes and records as players, and a Shapley value is generated for each attribute and each record. The following provides a discussion for attributes that similarly applies to records.

To accomplish the objective of deriving anomaly scores for the attributes in tabular data T, the following approach is used in some configurations. Based on the collection {Eₐ_{₁}, Eₐ_{₂}, . . . , Eₐ_{ₘ}} of evidence sets corresponding to m attributes, a score is computed for each attribute based on the following criteria. Criteria 1: The more is the number of unique records that are part of an evidence set, the higher should be its score. Criteria 2: The higher is size of an evidence set, the higher should be its score. The size of an evidence set captures statistical significance of the respective attribute being a potential candidate for anomaly.

A cooperative game is defined in order to compute scores of the evidence sets for attributes while capturing the above two criteria. In particular, a cooperative game (A,νa) is defined based on the attributes of tabular data as follows: (i) the set of attributes A is the set of players; and (ii) νₐ(⋅): 2^{m}→ [symbol] is a characteristic function that attaches a value to each subset of players. In particular, for each S⊆A, νₐ(S) is defined as the cardinality of the set of records which are members of at least one evidence set corresponding to the attributes in S. That is,

$${𝒱}_{a} ( S ) = \vert {⋃}_{{a}_{j} ∈ S} {E}_{{a}_{j}} \vert \qquad ( 3 )$$

For the above cooperative game, the Shapley values of evidence sets corresponding to attributes are computed. Note that the calculation of Shapley values for any arbitrary cooperative game is computationally hard due to the need for working with possible subsets of players. However, due to the specific structure of the cooperative game (Eₐ,νₐ), as shown below, it is possible to compute the Shapley values of the players (i.e. evidence sets) and thus for attributes efficiently in polynomial time.

The following result formally proves that the Shapley values of attributes can be computed efficiently using a closed form expression.

Lemma 1. In the cooperative game (Eₐ,νₐ), the Shapley value Øₐ (Eₐ_{ⱼ}) of each attribute aⱼ∈A can be computed as follows:

$${∅}_{a} ( {a}_{j} ) = {\sum }_{{r}_{i} ∈ {E}_{{a}_{j}}} \frac{1}{\vert \{ k : {r}_{i} ∈ {E}_{{a}_{k}} \} \vert}$$

Proof. The Shapley value of each attribute aⱼ using the permutation-based definition is as follows:

$$∅ ( {a}_{j} ) = \frac{1}{n !} {\sum }_{r} [ {𝒱}_{a} ( {P}_{R}^{{a}_{j}} ⋃ \{ {a}_{j} \} ) - {𝒱}_{a} ( {P}_{R}^{{a}_{j}} ) ] \qquad ( 4 )$$

where the sum ranges over the set R of all m! orders over the players (i.e. attributes) and P_{R}^{a}^{ⱼ} is the set of players in A which precede aⱼ in the order R. Now, it follows that from equations (3) and (4) that:

$$\begin{matrix}{∅}_{a} ( {a}_{j} ) = \frac{1}{n !} {\sum }_{r} {\sum }_{{r}_{i} ∈ {E}_{{a}_{j}}} [ \vert {𝒱}_{a} ( {P}_{R}^{{a}_{j}} ) ⋃ \{ {r}_{i} \} \vert - \vert {𝒱}_{a} ( {P}_{R}^{{a}_{j}} ) \vert ] \\ = \frac{1}{n !} {\sum }_{r} {\sum }_{{r}_{i} ∈ {E}_{{a}_{j}}} {I}_{{r}_{i} ∉ {P}_{R}^{{a}_{j}}} \\ ( I denotes the Indicator function ) \\ = \frac{1}{n !} {\sum }_{{r}_{i} ∈ {E}_{{a}_{j}}} {\sum }_{R} {I}_{{r}_{i} ∉ {P}_{R}^{{a}_{j}}} \\ = {\sum }_{{r}_{i} ∈ {E}_{{a}_{j}}} \frac{{\sum }_{R} {I}_{{r}_{i} ∉ {P}_{R}^{{a}_{j}}}}{n !} \\ = {\sum }_{{r}_{i} ∈ {E}_{{a}_{j}}} \frac{1}{\vert \{ k : {r}_{i} ∈ {E}_{{a}_{k}} \} \vert}\end{matrix} \qquad ( 5 )$$

Accordingly, the Shapley value of each attribute aⱼ∈{a₁, a₂, . . . , aₘ} is an independent sum of the originality of its records wherein the originality of each record is inversely proportional to the number of anomalous attributes it has. Note that those records that do not contain any anomalous attributes contribute zero towards Shapley values of the attributes (as per the cooperative game).

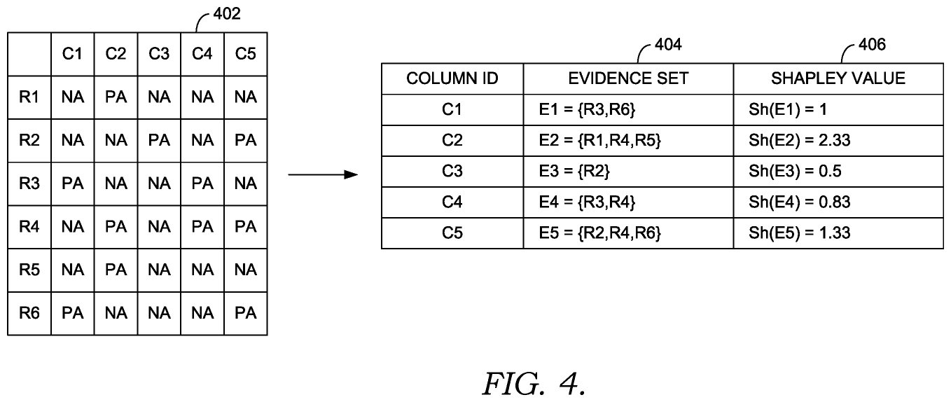

FIG. 4 provides an example illustrating computation of Shapley values of attributes. In particular, FIG. 4 shows a stylized and labeled tabular data 402 with five attributes and six records. Based on the placement of PA labels in this table, the evidence sets for the five attributes are:

$${E}_{{a}_{1}} = \{ R 3 , R 6 \} , \text{} {E}_{{a}_{2}} = \{ R 1 , R 4 , R 5 \} , \text{} {E}_{{a}_{3}} = \{ R 2 \} , \text{} {E}_{{a}_{4}} = \{ R 3 , R 4 \} , \text{} {E}_{{a}_{5}} = \{ R 2 , R 4 , R 6 \} .$$

The Shapley value for each attributes is computed based on its evidence set. As an example, the Shapley value of attribute a₄ (i.e., C4) is computed using its evidence set Eₐ_{₄}={R3, R4} as follows:

$${∅}_{a} ( {a}_{j} ) = \frac{1}{2} + \frac{1}{3} = 0.83 ,$$

wherein the first term ½ comes from the fact that R3 appears in two evidence sets (i.e. Eₐ_{ᵢ} and Eₐ_{₄}) and the second term ⅓ comes from the fact that R4 appears in three evidence sets (i.e. Eₐ_{₂}, Eₐ_{₄}, and Eₐ_{₅}). On similar lines, the Shapley values for other attributes are:

$${∅}_{a} ( {a}_{1} ) = \frac{1}{2} + \frac{1}{2} = 1 , \text{} {∅}_{a} ( {a}_{2} ) = 1 + \frac{1}{3} + 1 = 2.33 , \text{} {∅}_{a} ( {a}_{3} ) = \frac{1}{2} = 0.5 , \text{} {∅}_{a} ( {a}_{5} ) = \frac{1}{2} + \frac{1}{3} + \frac{1}{2} = 1.33 .$$

With reference again to FIG. 1, the anomalous data subset component 116 uses the anomaly scores (e.g., Shapley values) for attributes and records to define anomalous data subsets for the tabular data. In some instances, top-k anomalous data subsets are identified. The anomalous data subset component 116 orders the attributes and records based on their anomaly scores. In some instances, this is visualized by reshuffling the attributes and records in the tabular data based on the anomaly scores to provide an organized view of the anomalous data subsets in the form of blocks such that each block (i.e., anomalous data subset) includes of a subset of attributes and records. Accordingly, restructuring the attributes and records using their respective anomaly scores in this way leads to block structures in the tabular data, where each block structure includes a subset of anomalous attributes and records. Blocks in this visualization that are close to top left direction are those that are from the top-k anomalous data subsets.

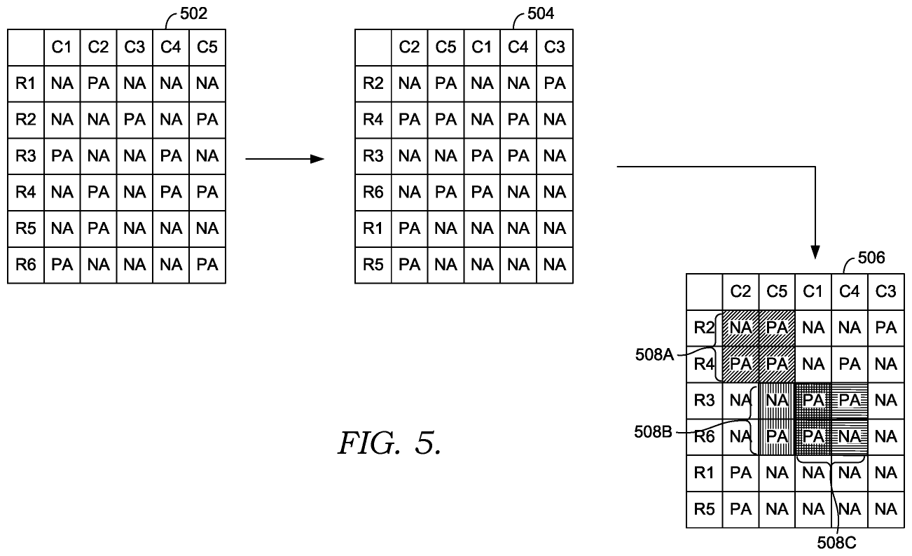

FIG. 5 provides an example illustrating this restructuring of tabular data and identification of block structures for anomalous data subsets. As shown at FIG. 5, labeled tabular data 502 is restructured based on anomaly scores for attributes and records to provide restructured tabular data 504, in which attributes (i.e., columns) with the greatest anomalies (e.g., highest anomaly scores) are shifted to the left, and records (i.e., rows) with the greatest anomalies (e.g., highest anomaly scores) are shifted up. It should be noted that restructuring of tabular data in this manner is provided by way of example only and not limitation. Other approaches could be employed, such as restructuring tabular data to place the attributes and rows with the highest anomalies towards the right and bottom.

In some aspects, visual indicators are applied to identified block data structures to show the anomalous data subsets. The visual indicators can comprise highlighting, cross-hatching, text formatting, or other visual mechanisms of identifying the block data structures. For instance, block data structures for anomalous data subsets are visually identified in the tabular data 506. In particular: a visual indicator 508A is applied that identifies a first anomalous data subset that includes attributes C2, C5 and records R2, R4; a visual indicator 508B is applied that identifies a second anomalous data subset that includes attributes C5, C1 and records R3, R6; and a visual indicator 508C is applied that identifies a third anomalous data subset that includes attributes C1, C4 an records R3, R6. As can be seen from FIG. 5, attributes and records can be included in multiple anomalous data subsets.

Returning to FIG. 1, the anomalous data system 104 further includes a user interface component 118 that provides one or more user interfaces for interacting with the anomalous data system 104. The user interface component 118 provides user interfaces to a user device, such as the user device 102 (which includes the application 108 for interacting with the anomalous data system 104). For instance, the user interface component 118 can provide user interfaces for, among other things, interacting with the anomalous data system 104 to enter tabular data. The user interface component 118 can also provide user interfaces for, among other things, interacting with the anomalous data system 104 to provides outputs identifying anomalous data subsets. For instance, a user interface could be provided to the user device 102 that lists anomalous data subsets identifying the subset of attributes and records in each anomalous data subset or that provides a view of the tabular data in which the tabular data has been restructured (e.g., with the most anomalous attributes and records moved towards the top left) with a visual indicator applied to each anomalous data subset (e.g., as shown in tabular data 506 of FIG. 5).

### Example Methods for Anomalous Data Identification

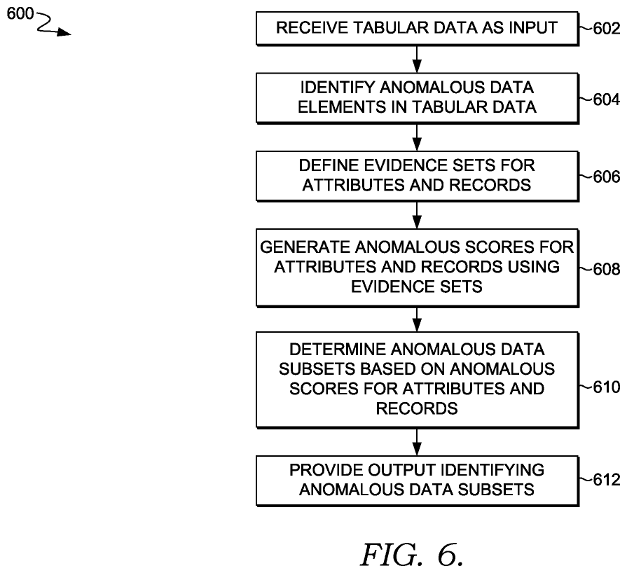

With reference now to FIG. 6, a flow diagram is provided that illustrates a method 600 for providing identifying anomalous data in tabular data. The method 600 can be performed, for instance, by the anomalous data system 104 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, tabular data is received as input. The tabular data generally includes a set of records having data elements, in which each data element provides a value for a corresponding attributes. Anomalous data elements are identified in the tabular data, as shown at block 604. In some embodiments, this could include determining an anomaly score for each data element indicative of a likelihood of each data element being anomalous. For example, in some configurations, a machine learning model is trained to predict values for attributes in the tabular data based on actual values for other attributes in the tabular data, and a reconstruction error or other prediction error is generated based on the predict value and the actual value for the attribute. The anomaly scores could be based on the determined prediction error. It should be understood that other approaches for identifying anomalous data elements in the tabular data could be employed in other embodiments of the present technology.

As shown at block 606, evidence sets are defined for attributes and records based on the identification of anomalous data elements. In some aspects, an evidence set for an attribute is the set of records in which the data element for that attribute is identified as likely being anomalous (e.g., based on the anomaly scores and/or labels). In some aspects, an evidence set for a record is the set of attributes in which the data element for the attribute is identified as likely being anomalous (e.g., based on the anomaly scores and/or labels).

Anomaly scores for attributes and records are determined using the evidence sets, as shown at block 608. In some instances, the anomaly scores are Shapley values. For instance, in some configurations, a cooperative game is defined using the evidence sets for the attributes and the records as players, and Shapley values are computed for the attributes and the records based on the cooperative game.

Anomalous data subsets are determined based on the anomaly scores for the attributes and the records, as shown at block 610. Each anomalous data subset identifies a subset of attributes and subset of records that contain anomalous data. In some aspects, the anomalous data subsets are ranked based the relative extent of their anomalies (e.g., based on the anomaly scores for the attributes and records in each anomalous data subset).

An output identifying the anomalous data subsets is provided, as shown at block 612. In some instances, the output comprises an indication of attribute and record subsets for the anomalous data subsets, which can be ordered based on the extent of their rankings (e.g., based on anomaly scores for the attributes and records). In some instances, the output comprises restructured tabular data in which attributes and records are ordered based on their anomaly scores. For instance, restructured tabular data could be provided in which the most anomalous attributes (e.g., attributes with the highest anomaly scores) are shifted to the left and the most anomalous records (e.g., records with the highest anomaly scores) are shifted towards the top. The restructured tabular data could also provide a visual indicator (e.g., highlighting, cross-hatching, boxing, etc.) identifying anomalous data subsets.

### Exemplary Operating Environment

Having described implementations of the present disclosure, an exemplary operating environment in which embodiments of the present technology can be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what can be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory can be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which can be built in. Illustrative components include a microphone, joystick, game pad, satellite dish, scanner, printer, wireless device, etc. The I/O components 720 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 can be equipped with depth cameras, such as, stereoscopic camera systems, infrared camera systems, RGB camera systems, and combinations of these for gesture detection and recognition. Additionally, the computing device 700 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by a computing device, cause the computing device to perform operations, the operations comprising:
receiving a set of tabular data records, each tabular data record comprising data elements for a plurality of attributes, each data element providing a value for a corresponding attribute;
generating an anomaly score for each data element of each tabular data record;
defining an evidence set for each attribute and each tabular data record based on the anomaly scores for the data elements;
generating an anomaly score for each attribute and each tabular data record using the evidence sets; and
providing an output identifying one or more anomalous data subsets determined based on the anomaly scores for the attributes and tabular data records, each anomalous data subset identifying a subset of attributes and a subset of tabular data records.

2. The one or more computer storage media of claim 1, wherein generating the anomaly score for a first data element of a first tabular data record comprises:
generating, using a machine learning model, a predicted value for an attribute corresponding to the first data element given one or more other data elements for the first tabular data record; and
determining a reconstruction loss based on the predicted value.

3. The one or more computer storage media of claim 1, wherein defining the evidence set for each attribute and each tabular data record based on the anomaly scores for the data elements comprises:
assigning labels to the data elements based on the anomaly scores; and
defining the evidence sets using the labels.

4. The one or more computer storage media of claim 1, wherein the labels comprise a first label indicating a corresponding data element as a possibly anomaly and a second label indicating a corresponding data element as not a possible anomaly.

5. The one or more computer storage media of claim 4, wherein the evidence set for a first attribute comprises an indication of tabular data records in which the data element for the first attribute is labeled with the first label.

6. The one or more computer storage media of claim 4, wherein the evidence set for a first tabular data record comprises an indication of attributes in which the data element for the first tabular data record is labeled with the first label.

7. The one or more computer storage media of claim 1, wherein the anomaly score for each attribute and each tabular data record comprises a Shapley value.

8. The one or more computer storage media of claim 7, wherein the Shapley value for each attribute and each tabular data record is determined by defining a cooperative game using the evidence sets for attributes and records as players.

9. The one or more computer storage media of claim 1, wherein the output comprises restructured tabular data in which the tabular data records and attributes are ordered based on the anomaly scores for the tabular data records and the attributes, and wherein the restructured tabular data includes a visual indicator identifying a first anomalous data subset.

10. A computer-implemented method comprising:
receiving, by a data element analysis component, tabular data comprising a set of records, each record including data elements for a set of attributes;
assigning, by the data element analysis component, a label to each data element indicative of whether each data element is anomalous;
determining, by an evidence set component, an evidence set for each attribute and each record using the labels;
generating, by an anomaly scoring component, an anomaly score for each attribute and each record based on the evidence sets; and
outputting, by a user interface component, an indication of one or more anomalous data subsets based on the anomaly scores for the attributes and records, each anomalous data subset comprising a subset of attributes and a subset of records.

11. The computer-implemented method of claim 10, wherein the method further comprises:
generating an anomaly score for each data element, wherein the data elements are assigned labels based on the anomaly scores.

12. The computer-implemented method of claim 11, wherein generating the anomaly score for a first data element for a first record comprises:
generating, using a machine learning model, a predicted value for an attribute corresponding to the first data element given one or more other data elements for the first record; and
determining a reconstruction loss based on the predicted value.

13. The computer-implemented method of claim 11, wherein the labels comprise a first label indicating a corresponding data element as a possibly anomaly and a second label indicating a corresponding data element as not a possible anomaly.

14. The computer-implemented method of claim 11, wherein the anomaly score for each attribute and each tabular data record comprises a Shapley value.

15. The computer-implemented method of claim 11, wherein the anomalous data subsets are ordered based on the anomaly scores for the subsets of attributes and the subsets of records corresponding to the anomalous data subsets.

16. A computer system comprising:
one or more processors; and
one or more computer storage media storing computer-useable instructions that, when used by the one or more processors, causes the one or more processors to perform operations comprising:
generating, by a data element analysis component, an anomaly score for each data element in tabular data, the tabular data comprising a set of records, each record including data elements for a set of attributes;
assigning, by the data element analysis component, labels to the data elements based on the anomaly scores for the data elements;
determining, by an evidence set component, an evidence set for each attribute and each record using the labels;
generating, by an anomaly scoring component, an anomaly score for each attribute and each record based on the evidence sets;
generating, by an anomalous data subset component, one or more anomalous data subsets based on the anomaly scores for the attributes and records, each anomalous data subset comprising a subset of attributes and a subset of records; and
outputting, by a user interface component, an indication of the one or more anomalous data subsets.

17. The computer system of claim 16, wherein generating the anomaly score for a first data element of a first record comprises:
generating, using a machine learning model, a predicted value for an attribute corresponding to the first data element given one or more other data elements for the first record; and
determining a reconstruction loss based on the predicted value.

18. The computer system of claim 16, wherein the labels comprise a first label indicating a corresponding data element as a possibly anomaly and a second label indicating a corresponding data element as not a possible anomaly.

19. The computer system of claim 16, wherein the anomaly score for each attribute and each tabular data record comprises a Shapley value.

20. The one or more computer storage media of claim 1, wherein the output comprises restructured tabular data in which the records and attributes are ordered based on the anomaly scores for the records and the attributes, and wherein the restructured tabular data includes a visual indicator identifying a first anomalous data subset.
